(19) United States
(12) Patent Application Publication
(10) Pub. No.: US 2017/0221071 A1
(43) Pub. Date: Aug. 3, 2017

(54) ISSUE RESOLUTION PLATFORM

(71) Applicant: Uber Technologies, Inc., San Francisco, CA (US)

(72) Inventor: Michael Aaron Eton York, San Francisco, CA (US)

(21) Appl. No.: 15/011,650

(22) Filed: Jan. 31, 2016

(51) Int. Cl. G06Q 30/00; G06Q 10/06

(52) U.S. Cl. CPC G06Q 30/016; G06Q 10/063112

(57) ABSTRACT

An issue resolution platform is implemented on a computer system that communicates with user devices over a network.

### BACKGROUND

Issue resolution refers to supplementary services offered by businesses and other enterprises to address issues raised by a customer base. Typical issues that are raised can include problems encountered by an individual customer that results in dissatisfaction by the customer. When issues are effectively resolved in a timely fashion, businesses services are more likely to maintain goodwill with the customer that raised the issue, even when the particular customer's experience was problematic.

There are an increasingly number of decentralized services where customer experience and quality control become more difficult to manage. For example, numerous on-demand services currently exist which employ service providers who are part of the user base for the service. Such types of services can have a great amount of demand, but when problems arise with customers, information needed to understand the issues can become more difficult to obtain (e.g., the employee may be part-time contractor) as compared to centralized businesses.

### BRIEF DESCRIPTION OF THE DRAWINGS

FIG. 1 illustrates a system for providing a network-based service on which an issue resolution platform is provided.

FIG. 2 illustrates an example computer system on which an issue resolution platform can be implemented for use with network-based services (e.g. on-demand human workforce service).

FIG. 3A through FIG. 3C each illustrate an agent interface that implements functionality provided through an issue resolution platform.

FIG. 4 illustrates an example method for implementing an issue resolution platform, according to one or more examples.

### DETAILED DESCRIPTION

According to some examples, the computer system operates to receive an issue resolution request from a client device operated by a user. The issue resolution request may identify an issue arising in connection with the user receiving a service from a service provider. The computer system may select a human agent from a pool of human agents. The selection of the human agent may be based at least in part on an attribute of the issue resolution request and a characteristic of the human agent that is specific to at least a sub-category of human agents in the pool. The resolution action can be performed automatically in response to an action by the selected human agent.

Among other benefits and technical effect, embodiments provided herein include an issue resolution services platform system which can eliminate delays experienced by a user or customer in servicing an issue resolution request generated within a queue of a multitude of such requests. In some examples, a network system is implemented to a comprehensive interface for distributing issues to customer service personnel, and for facilitating individual customer service representatives to address assigned issues.

In some examples, an issue resolution platform is implemented to optimize the selection of human agents that are best suited for resolving particular issues. The issue resolution platform also provides functionality to automate aggregation of information for determining the resolution action, as well as performing other actions in order to enable issues to be more rapidly resolved. The issue resolution platform further enables intelligent pairing as between issue resolution requests and human agents for responding to the requests.

In some examples, an issue resolution platform enables an action by the resolution agent to synchronously trigger another automated resolution action (or set of actions), such as an update to a user account. In context of a large-scale customer-oriented services (such as provided by on-demand services) which can generate thousands of issues for resolution, an issue resolution platform as described by various examples promotes queue reduction and manageability. Additionally, a throughput of the issue resolution platform is increased with better transactional traceability and accountability.

Examples include an issue resolution platform that is implemented using a network service or computer system that operates to receive an issue resolution request from a client device having an associated client device account. The issue resolution request identifies a service provider, the service provider having an associated service provider profile. An issue category can be selected or otherwise determined for the issue resolution request, based on, for example, input accompanying the request. A component of the issue resolution platform can select a human agent based on a pairing of the issue category with a characteristic of the human agent.

As used herein, a client device refers to devices corresponding to desktop computers, cellular devices or smartphones, laptop computers, tablet devices, wearable electronic devices, television (IP Television), etc., that can provide network connectivity and processing resources for communicating with the system over a network. In numerous implementations, a client device and/or vehicle communication device can also operate a designated application configured to communicate with the service arrangement system. For example, a rider embarking on a trip along travel route may have a mobile computing device that executes a rider application having functionality for requesting and receiving ride services, such as for viewing availability of transport services provided through a transport arrangement service.

Still further, while some examples of the issue resolution system described herein relate to transport services, the system can be applied to other services contexts.

Among other benefits, examples recognize that issue resolution can be significant for advancement of on-demand services which use a diverse population of service providers. Examples described enable functionality for enhancing the ability of a human agent to resolve issues of the customer.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some embodiments described herein can generally require the use of computing devices, including processing and memory resources. For example, one or more embodiments described herein may be implemented, in whole or in part, on computing devices such as servers, desktop computers, cellular or smartphones, laptop computers, printers, digital picture frames, network equipment (e.g., routers), wearable devices, and tablet devices. Memory, processing, and network resources may all be used in connection with the establishment, use, or performance of any embodiment described herein (including with the performance of any method or with the implementation of any system).

Furthermore, one or more embodiments described herein may be implemented through the use of instructions that are executable by one or more processors. These instructions may be carried on a non-transitory computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, embodiments may be implemented in the form of computer-programs, or a computer usable carrier medium capable of carrying such a program.

### System Description

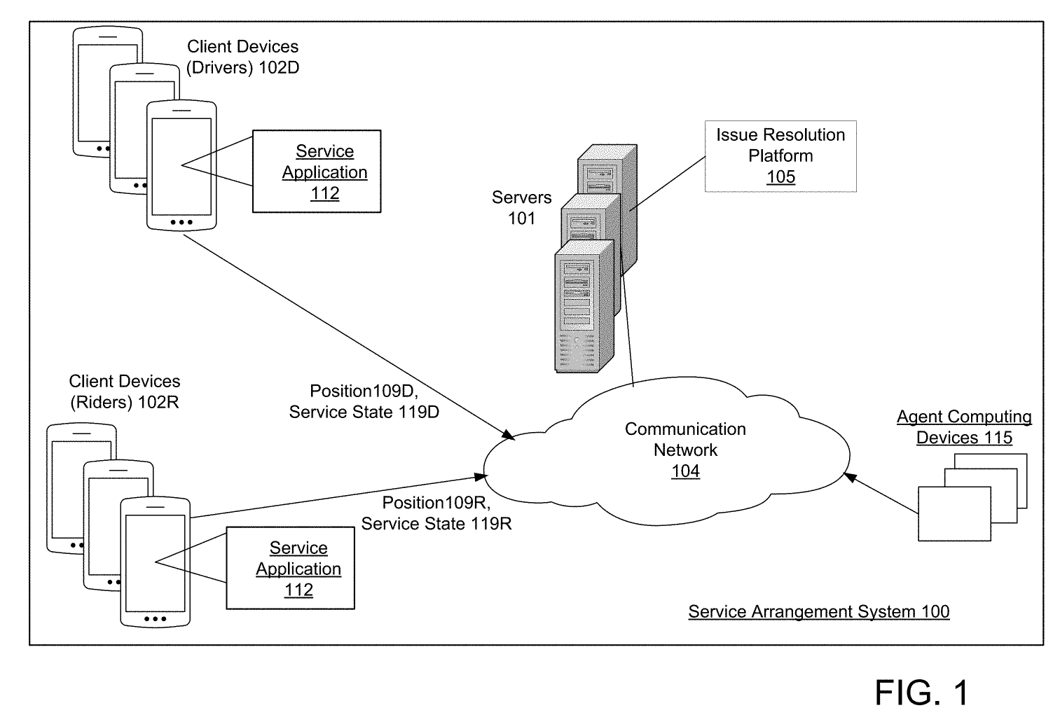

FIG. 1 illustrates a system for providing a network-based service on which an issue resolution platform is provided. According to an example of FIG. 1, a service arrangement system 100 is distributed amongst centralized network machines (e.g., servers) and client devices 102 which are operated by users of the service arrangement system 100. The centralized network machines may include a network service server 101 (which can represent a combination of servers to provide an issue resolution platform), and the client devices 102 can be operated by multiple classes of users (e.g., service provider class users, customer class users). The service arrangement system 100 can be heterogeneous in nature, in that the various end user devices can operate on multiple different computing platforms (e.g., multi-functional cellular telephony/messaging devices, tablet device, wearable electronic device, etc.). The implementation of service arrangement system 100 can include or provide for client devices 102, each having functionality for establishing and/or maintaining a respective communication channel with servers or other network resources of the service arrangement system 100. By way of example, the individual client devices 102 can establish and maintain an Internet Protocol connection that is established over a wireless communication medium.

The service arrangement system 100 can be implemented using multiple networks (e.g., cellular networks, Internet) and communication mediums (e.g., such as provided through cellular, 802.11 or Bluetooth protocols, Ethernet, etc.), which are collectively represented as a communication network 104.

The client devices 102 of the various end users can be heterogeneous in terms of device platform or form factor. In one implementation, each client device 102 executes a service application 112 that establishes a communication channel with the server 101 of the service arrangement system 100. The service applications 112, when executed on corresponding client devices 102, can also interface with, for example, local hardware resources such as geo-aware components (e.g., GPS) and sensors, as well as data sets (e.g., third-party maps) and other application functionality (e.g., calendar application).

Among other technological features, the service arrangement system 100 operates to aggregate data from various client devices 102 in order to provide a variety of functionality and service enhancements with regard to one or more types of on-demand services (e.g., transportation arrangement, parcel delivery, food orders). In one aspect, the service arrangement system 100 implements technology to maintain privacy of end users, while at the same time employing client devices 102 as data acquisition elements of the network platform. According to examples, the technological considerations for implementing an on-demand arrangement service that uses the network platform are considerably more complex than, for example, simply protecting user data stored on a computing device. Examples recognize that for many services and service enhancements, the service arrangement system 100 may be implemented to acquire user information from end users devices 102R-n (representing customer client devices) and 102D-n (representing service provider client devices). Among other challenges, the service arrangement system 100 aggregates private information in real-time from the client devices, including (i) position information 109R, 109D from client devices 102R, 102D for customers and providers, and/or (ii) service status information 119R, 119D, in order to provide service and non-private service related information for the population of users, as described in greater detail below.

According to examples, various aggregations of user information can be obtained and formulated into concrete, real-time information that does not compromise privacy of the end users (whether customer or service provider), such that private information of a given user is not disclosed to another user under a condition or otherwise in a manner that would violate a privacy constraint, condition or rule. By way of example, the service arrangement system 100 can be used to obtain the real-time position information 109R, 109D and service status information 119R, 119D from the client devices of individual users. The service status information 119R can identify information such as whether a customer (as a class of user) has requested a service, whether the customer is receiving the transport service, or whether the customer is likely to make a service request (e.g., based on the user interaction with a corresponding client user device). The status information 119D for a service provider (as a class of user) can include information that indicates whether the service provider is available to provide a service, assigned but not yet at a service site, or performing a service for a customer (e.g., “occupied”). As an addition or alternative, the status information 119D can indicate whether the service provider is assigned to a service request made by a customer class user through the system 100. As another addition or alternative, the status information 119D can indicate whether the service provider has been assigned the service request for a duration of time that permits reassignment (e.g., when a driver has yet to arrive at a pickup location and the current assignment has not exceeded a threshold time limit).

With further reference to an example of FIG. 1, the service arrangement system 100 can be implemented as a distributed network platform, in order to securely acquire and aggregate information from client devices 102R, 102D without violating privacy constraints or rules. As a distributed network platform, the service arrangement system 100 is able to acquire accurate, real-time and reliable information that can serve the purpose of intelligent or optimized implementation of assigning service providers to service requests of customers.

In some examples, the network service servers 101 implement an issue resolution platform 105 for resolving issues arising from service providers providing services to customers. The issue resolution platform can be implemented using programmatic components that reside entirely, or substantially on the servers 101. In some variations, the issue resolution platform 105 can include or utilize programmatic components which reside on the client devices 102. For example, the issue resolution platform 105 can include programmatic components that include or are provided with the service application 112 executing on the respective client devices 102 of the customers and service providers.

In some examples, the issue resolution platform 105 can include a third set of computing devices 115, operated by human agents who interact with the issue resolution platform 105 (via the communication network 104) to resolve issues as they arise. The computing devices 115 of the human agents can include, for example, desktop computers, enterprise terminals and/or mobile computing devices. As described with some examples, the computing devices 115 can each operate to provide an interface for interacting with the issue resolution platform 105. As described with various examples, the interface can include functionality for enhancing the use of human agents operating the computing devices 115.

In some examples, the service application 112 executes on the customer class computing devices in order to enable features for enabling customers to notify the issue resolution platform 105 of an issue (e.g., complaint). For example, in the context of transport services, the customer can open the service application 112 and select a menu feature to initiate a process by which the customer can make a complaint about a driver or trip. When operated in this role, the service application 112 can execute to perform various types of operations to facilitate subsequent issue resolution, including data gathering operations (some of which can be enhanced when performed at the time of the complaint). For example, if the customer uses the service application 112 to make a complaint immediately after a trip provided from a service provider vehicle, the service application 112 can identify the preceding trip and the customer's current location as context for the customer's complaint. The service application 112 can transmit such information (e.g., trip identifier, trip log, information about the complaint, etc.) along with identification of the user to the network service server 101. The issue resolution platform 105 can then process the issue resolution request from the user, as described with various examples below. In another example, the customer can access information about previously requested and/or completed trips (e.g., the customer's trip history) from the service application 112, select a particular trip, and make a customer service request in connection with that trip.

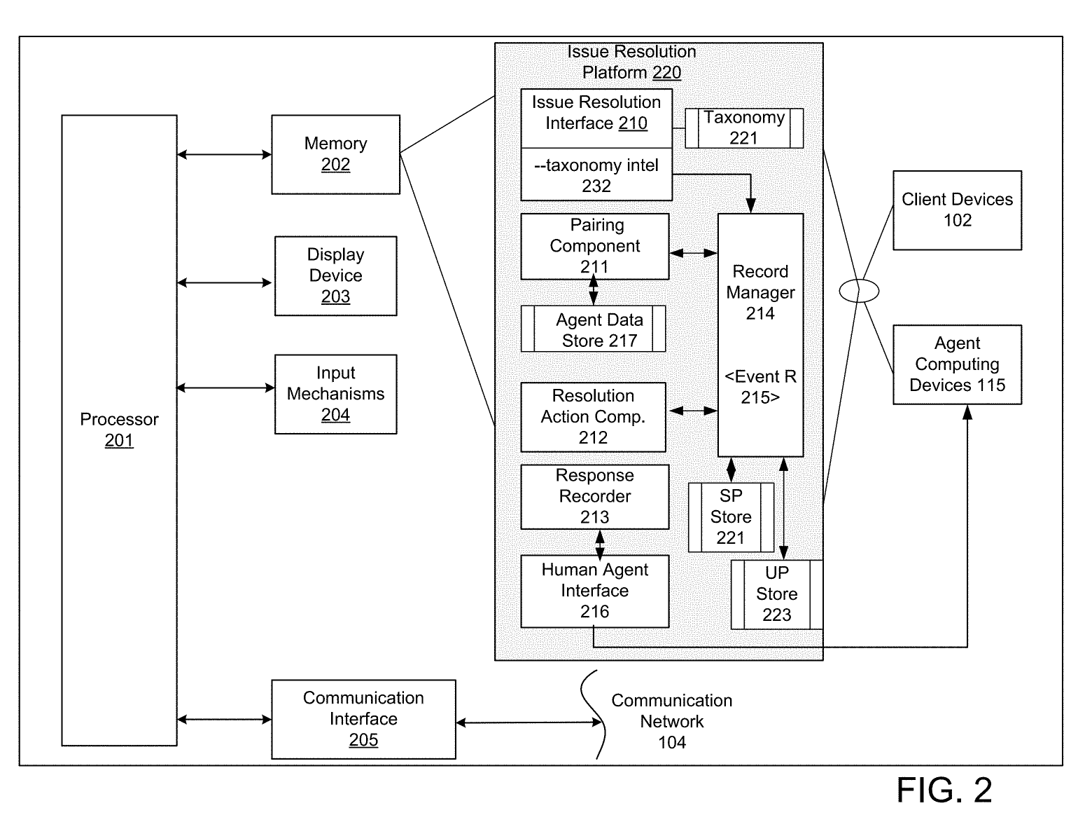

FIG. 2 illustrates an example computer system on which an issue resolution platform can be implemented for use with network-based services (e.g. on-demand human workforce service). In FIG. 2, a computer system 200 includes a processor 201 (representing one or multiple processors), memory 202, display device 203, input mechanisms 204 and communication interface 205 (e.g., communicative coupling to communication network 104). The memory 202 can store instructions and other data (e.g., temporary variables) for execution. The processor 201 can execute the instructions from memory 202 to provide an issue resolution platform 220. In some variations, the computer system 200 can implement the issue resolution platform 220 using components that are distributed over a network, including components that reside with client devices 102 or agent computing devices 115. Thus, while some examples may provide for the computer system 200 to be a server or combination of servers, variations to such examples may extend some or all of the functionality, features and components of the computer system 200 to alternative computing environments. As shown by an example of FIG. 2, the computer system 200 for implementing the issue resolution platform 220 can include client devices 102 and agent computing devices 115, so that some logical or programmatic components of issue resolution platform 220 reside with client devices and/or agent computing devices 115. In variations, the computer system 200 can include shared machines, such as virtual machines that are provided as part of a data center.

The processor 201 can access the instructions to implement at least a significant portion of the issue resolution platform 220. Additionally, issue resolution platform 220 can be implemented with instruction sets which can be executed on a server, combination of servers, client devices 102, and/or agent computing devices 115. For example, the processor 201 can communicate instructions to other computing devices (e.g., via the communication network 104) which can collectively implement the issue resolution platform 220.

When operative, the issue resolution platform 220 can include issue resolution interface 210, pairing component 211, one or multiple resolution action components 212, response recorder 213, record manager 214 and human agent interface 216. The issue resolution interface 210 can process incoming issue resolution requests from various sources, such as client devices 102. The issue resolution interface 210 can also include a component that is resident on individual client devices 102 (e.g., as a feature or interface of a service application) to facilitate a user in composing an issue for resolution. The issue resolution platform 220 can also implement the network side portion of the issue resolution interface 210 to receive issue resolution requests from the various sources. Thus, the issue resolution interface 210 enables the issue resolution platform 220 to receive issue resolution requests from various users in different context and for different reasons. For example, an issue resolution request may be received from a customer client device, a service provider client device, or a webpage interface. Examples further contemplate that issue resolution requests can originate at various times in connection with different types of events, such as, during or immediately after a complainant receives or performs a requested service through the service arrangement system 100 (see FIG. 1). The issue resolution requests can also pertain to different aspects of a provided service. For example, the complainant may be the passenger of a transport provider who makes an issue resolution request because he or she is unhappy with the duration of the trip or with a manner in which this service was provided.

In some examples, memory 202 maintains a taxonomy 227 of categories for use with the issue resolution interface 210. The issue resolution interface 210 can include definitions of subcategories to various degrees, based on statistical accumulation of issues that arise over time when services are provided through the system 100. Still further, alternative taxonomies can be developed for different classes of entities which interact with the issue resolution platform 220. The categories of the different taxonomies can be associated with the issue resolution automatically and/or through manual input. For example, the complainant can navigate a menu to select a category for the issue resolution, or compose a free-form textual statement as a complaint. In the latter case, keywords can be used to automatically associate the statement with a category from a predetermined taxonomy.

In some examples, different taxonomies are provided to different classes of users, such as an outward facing taxonomy for customers or users of a service. In such examples, customers may be provided a first categorical taxonomy from which a category for the issue they wish to have resolved can be selected, while human agents operating terminals 115 can utilize an alternative taxonomy that optimizes issue resolution time. The issue resolution interface 210 can include taxonomy intelligence 232, to develop information and data for defining taxonomies that optimize navigation and taxonomy selection for a given class of user or entity (e.g., customer or human agent pass with resolving an issue).

In variations, the categorical selection used in generating the issue can be accompanied with a template that guides the complainant in providing necessary or desired information. For example, for a customer complaint about a trip, the template associated with the relevant category may require the customer to provide details about the trip (e.g., when the trip occurred, the destination of pickup, confirmation of the driver, etc.).

The issue resolution interface 210 can preprocess an issue resolution request, and the receipt of the issue resolution request can generate an event record 215 that is subject to a workflow. The event record 215 can include, for example, a record identifier, a time of submission, one or more category designations, the name or identifier of the submitter, as well as various other types of information (e.g., geographic region where issue arose, time when event occurred, etc.). The category designations can be manual and/or programmatically determined. For example, the issue resolution interface 210 (or other components or logic) can categorize or re-categorize an issue resolution request based on separate taxonomy that is optimized for selecting an appropriate human agent.

The record manager 214 includes logic that subjects the event record 215 to a workflow. According to some examples, the record manager 214 can utilize different data sources in order to aggregate information necessary for resolving an issue. The different data sources can include a service profile store 221, which can independently confirm or otherwise provide details of a given service request which may be the subject of the complaint. The data sources can also include a user profile store 223, which can maintain profile information for different classes of users (including service provider and customer). The service profile store 221 can include additional information, such as contextual information about a service performed which is the subject of the issue resolution request. For example, for transport services, the service profile store 221 can identify the route taken by a driver, whether the route was the shortest in time or distance, whether traffic or other congestion existed on other routes, or whether the customer requested a particular route. Still further information such as weather, time, and historical information about the driver or drop-off can be maintained by the service profile store 221 and/or the user profile store 223. In examples where the service provided is a trip along a travel route, details including (but not limited to) trip route taken, cost, trip date and time, travel time, method of payment, and identification of the user and service provider involved may be displayed, along with menu options and functionality, such as via a provided action bar, to enable resolution of any number of possible resolution actions that a resolution agent or resource may take to rectify or resolve the issue or complaint. The record manager 214 can update the event record 215 so that it contains or is associated (e.g., via data pointers) with information from multiple data sources may be relevant to individual issue resolution requests.

When the issue resolution platform 220 is implemented, the pairing component 211 includes logic to select the resource or resources for handling issue resolution requests. The resources available to the pairing component 211 can include human agents, as well as programmatic or data resources. The factors used in determining what resources to assign to an issue resolution request can vary significantly. The record manager 214 can interact with the pairing component 211 to identify a resolution resource for handling the event record 215.

Examples recognize that for the issue resolution platform 220 to be effective and efficient, a rate of incoming issue resolution requests should be less than a rate of resolved issues. In particular, when there are tens or hundreds of thousands of customers and or service providers active during a given segment of a day, even a small percentage of complaints can result in hundreds or thousands of requests being received in short durations of time (e.g., one hour). The number of sources which may be needed to handle the volume of issue resolution requests can thus be significant, numbering in the thousands or even greater orders of magnitude. To better handle incoming requests, examples recognize that pairing each issue resolution request with a suitable or most suitable resolution resource facilitates expediency and ultimately enables fewer sources that are human agents for issue resolution request. Moreover, in such context, examples recognize that it is optimal to reduce, as much as possible, the amount of time needed to assign a source for the issue resolution request. When thousands or tens of thousands of sources are available for use with issue resolution requests that are of similar magnitude, technological solutions (such as provided with the computer system 200) are needed in order for the issue resolution system to remain operative, particularly when the pairing of source to issue resolution request is done with intelligence in order to increase efficacy of issue resolutions as a whole. By contrast, human operators would not able to pair issue resolution request with sources in requisite time periods which can measure in fractions of seconds.

An issue resolution request can be handled through the issue resolution platform 220 by way of a resolution action. The record manager 214 can trigger the pairing component 211 to identify when an issue resolution request can be handled through programmatic or automated response mechanisms. For example, a common complaint can be one in which a rider of a transport service requests confirmation that the route taken by the driver was the proper route. The pairing component 211 can process an incoming issue resolution request based on categorical designation, keywords, included fields and other information in order to forward the issue resolution request to select a source for handling the resolution request.

According to some examples, the sources for handling the issue resolutions can be programmatic or human. The issue resolution platform 220 can include a collection of resolution action components 212 which can perform different tasks in connection with an event record 215 of an issue resolution request. The pairing component 211 can be triggered to identify a type of resolution action needed, and the record manager 214 can provide information from the record event to the programmatic process that executes as the selected resolution action component 212.

In an example in which a rider wishes to confirm the route taken was appropriate, the selected resolution action component 212 can be configured to confirm that route selection based on information included with the resolution request. Each resolution action component 212 can perform or otherwise output an action to handle the issue resolution request (e.g., refund a portion of charges to the user account for the service and/or generate response email to an issue resolution request). In variations, the selected resolution action component 212 can initiate a confirmatory action, meaning an action that is fulfilled by another action, such as human input to confirm the initiated action (e.g., refund a portion of the service charge upon approval by human agent). The selected resolution action component 212 can perform the required steps for a given action or outcome, such as an action of accessing an account of a submitter of the resolution request for purpose of refunding funds to that individual's account, and/or generating a form email for the customer and/or service provider. In this manner, the issue resolution request can be resolved quickly through automation, when human agents are sought for approval rather than action.

Still further in some variations, multiple possible outcomes can result when a selected resolution action component 212 is invoked for an issue resolution request. For example, the selected resolution action component 212 can perform actions that include issue escalation, linking the issue resolution request to another request that is being handled through another resource of the human agent interface 216, or returning a response to the record manager 214 indicating that the selected source is not the appropriate source for handling the issue resolution request.

In variations, the pairing component 211 can select a source for performing the issue resolution that is a human agent. An agent data store 217 can maintain agent profiles for individual agents that operate through the human agent interface 216. A selected human agent can be contacted through the human agent interface 216 and provided information from the event record 215. The selection of the particular agent can factor numerous considerations that go beyond characteristics of the particular issue resolution request. In some examples, pairing component 211 selects agents based on category, availability of the respective agents and/or a size of a queue for handling issue resolution requests. Still further, some variations provide that the human agent interface 216 detects when particular types of issues (e.g. difficult issues) are properly handled (e.g., based on a rating or feedback from the complainant) and then associates the particular human agent with the specific issue. In this way, some human agents can become experts for a particular issue, thereby preserving time-consuming resources which may otherwise be expanded when a less suitable human agent takes on a difficult or complex issue resolution request.

In some examples, the pairing component 211 extracts or otherwise identifies attributes related to a particular issue resolution request for purpose of selecting the human agent, or forming a pool of human agents from which final selection can be made. The attributes can be based on contextual aspects of the issue resolution request, rather than the actual content of the request. Attributes related to selection or matching of a particular resolution agent can include, for example, a geographic location (e.g., country, city) of the human agent or of the complainant, a time of day, an expertise or knowledge required for handling issues of the particular category, a native language of the complainant, proximity in time to a prior issue raised by the complainant and/or a previous human agent who responded to the issue. The pairing component 211 can use such aspects to make selections of human agents in order to, for example, (i) preserve objectives or goals of the issue resolution platform 220 (e.g., ensure quality of response while minimizing response time, maintain relationship between human agent and complainant if complainant has multiple issue resolution request and provides good feedback of the human agent); (ii) preclude particularly difficult issue resolution requests or complainants from taxing the issue resolution platform 220 (e.g., pair issue resolution request from specific user of a relatively rare native language with human agent capable of speaking or writing in the same native language); (iii) avoiding violation of laws, rules or etiquette of customs when pairing a particular issue resolution request with human agents (e.g., avoid pairing issue resolution request from particular country or type to human agents who reside in a country where such engagement is unlawful or against custom).

In selecting an appropriate agent to handle an issue resolution request, the pairing component 211 can apply weights and/or use deterministic logic. In some implementations, the pairing component 211 may weight proximity in time between a particular user's issue resolution requests such that proximity in time can be substantially determinative of the agent selection. For example, if a given user generates an issue resolution request that is deemed resolved by a selected human agent, but then makes another issue resolution request (perhaps of the same category) within a threshold period of time (e.g., within 5 minutes), the proximity in time can be viewed as a strong indicator that the prior human agent has the most background information for the second request and thus is the most appropriate source for receiving the second issue resolution request.

The weights can also allow manipulation of acceptable wait times before the issue resolution request is received by the human agent. For example, certain native languages can be viewed as more rare amongst the population of human agents. When the issue resolution request comes in from a user who has the particular native language (but who may or may not have composed the issue resolution request in the native language), the weights affecting the selection of the human agent may reflect considerations of need by the user (e.g., issue resolution request comes in that particular native language and/or the user has no other known language) or comfort (e.g., the user profile indicates a particular native language even when the issue resolution request is in English). In such instances, the weights can also expand the acceptable default wait time for forwarding the issue resolution request to a selected human agent. For example, in the case where need for native language speaker is paramount, the acceptable wait time for the issue resolution request may be indefinite until a human agent who can communicate in the native language becomes available.

In the case where the issue resolution request comes in immediately after a prior request from the same user, the weight assigned to a targeted human agent can extend the acceptable wait time for assignment of the issue resolution request, in order to increase the likelihood that the same agent who handled the first request will handle the second request. However, while the weight may extend the acceptable wait time, in the example provided, the acceptable wait time may not exceed a particular threshold, else the default selection process may be invoked where the human agent is selected from a pool based on general expertise, randomness or other default considerations. Thus, the in this regard, the examples provide a mechanism by which the pairing component 211 can select human agents, as well as vary the acceptable wait time for assigning the issue resolution request to a targeted human agent. Additionally, while resolution issue requests can be queued based upon availability of a targeted agent, the issue resolution request at hand may be advanced or moved backward in the queue of requests based on weights or prioritization invoked as a result of attributes of the incoming request.

As described in greater detail, the issue resolution platform 220 can include human agent interface 216 to facilitate human agent interaction with the issue resolution platform 220. The human agent interface 216 can be provided in the form of a webpage, application interface, or other programmatic mechanism that generates a visual and/or audio display of content, such as reflecting the issue resolution request, the category of the request, and/or information retrieved from records related to the complainant, service provider, and/or service is performed.

In some examples, the human agent interface 216 can include triggers which are shared by one or more of the resolution action components 212, so that a human generated action that is responsive to an issue resolution request also includes an automated action that is triggered with performance of the human action. For example, certain actions, such as the human agent composing and/or sending an email can invoke a trigger to cause the resolution action components 212 to perform a designated action coinciding with the resolution of the request. In this manner, the resolution action components 212 can perform a resolution action synchronously with the human agent performing a corresponding action. For example, the human agent may utilize the human agent interface 216 to select (or compose) a response to an issue resolution request for a partial refund. The category of the issue resolution request can dictate or preselect the form that the human agent is to use. When the human agent completes the form, a message can be triggered by the human agent (e.g., agent hits ‘send’). This event triggers the resolution action components 212 to perform a coinciding action, based on, for example, values provided in the fields by the human agent. For example, the resolution action components 212 can perform actions to insert a partial refund of a given amount into the account of the complainant. At the same time, the message that is sent from the human agent can confirm the refund, to the customer and/or to other human agents or archival repository etc.

Among other benefits, the process by which an issue is raised and resolved is significantly expedited through the use of automation. In particular, the issue resolution platform 220 is provided to include or otherwise utilize distributed programmatic interfaces and components to reduce or eliminate manual input when issues with the corresponding service arise for the user. For example, the service application 112 (see FIG. 1) of the client device 102 can automatically communicate, to the computer system 200, an identifier of the customer when an issue resolution request is made. The service application 112 can also automatically extract and send information about prior uses of the arranged service. The service application can also determine and communicate contextual information, such as time and location where the service was provided. Likewise, the human agent can view a record of the issue resolution request with pre-populated information, thus minimizing the interaction required by the human agent with the customer (e.g. unless escalation are complexity arise). Still further, programmatic components of the issue resolution platform 220 can merge or otherwise associate the output from the human agent via the human agent interface 216 (e.g., outgoing communication to customer and/or internal communication memorializing the action taken) with the action taken via the selected resolution action component 210, in order to generate a complete, auditable record of the issue resolution request.

The actions of the human agent can also result in supplemental or alternative outcomes. In some variations, the issue resolution platform 220 can be implemented to include response recorder 213 to extract information from the outgoing message of the human agent. For example, the response of the human agent can include text which can serve as a template for when subsequent issue resolution requests share a same content and/or context. In this way, the human agent interface 216 can present issue resolution requests to human agents with response templates that include pre-populated information (e.g., generic and case-specific information) and content that is generic but highly specific to the particular issue.

### Example User Interfaces

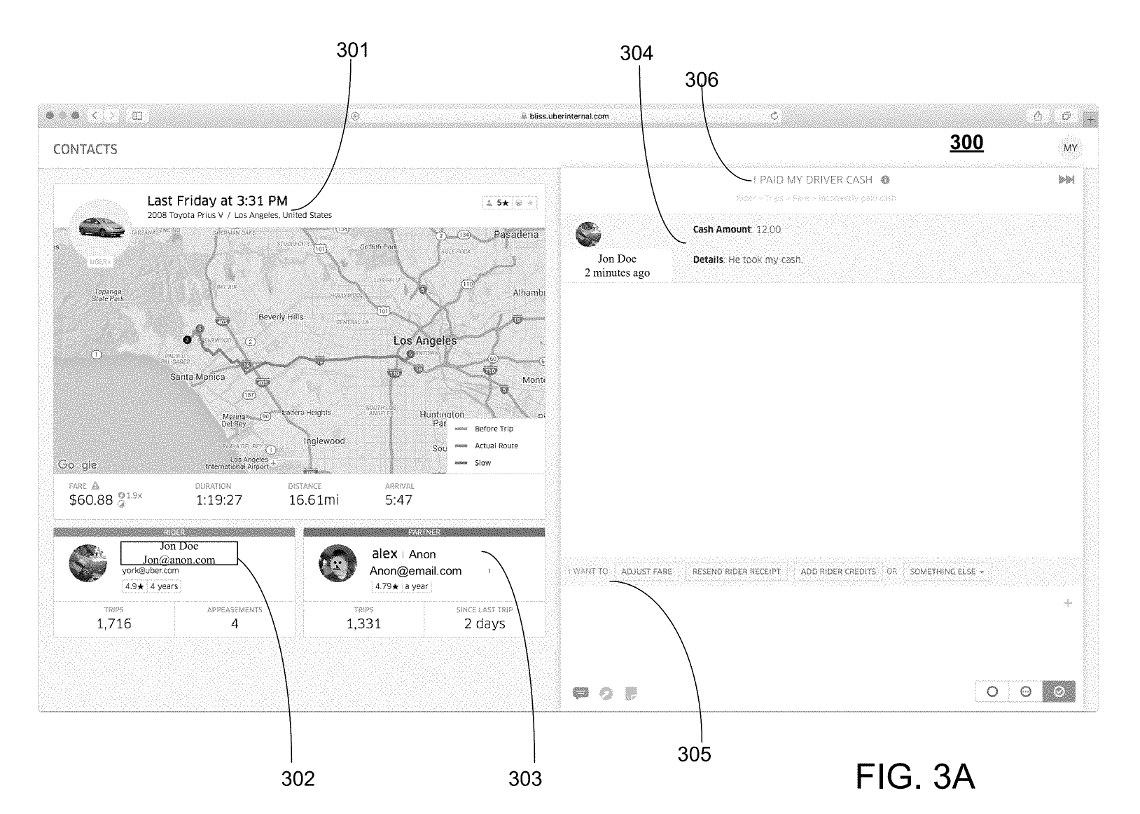

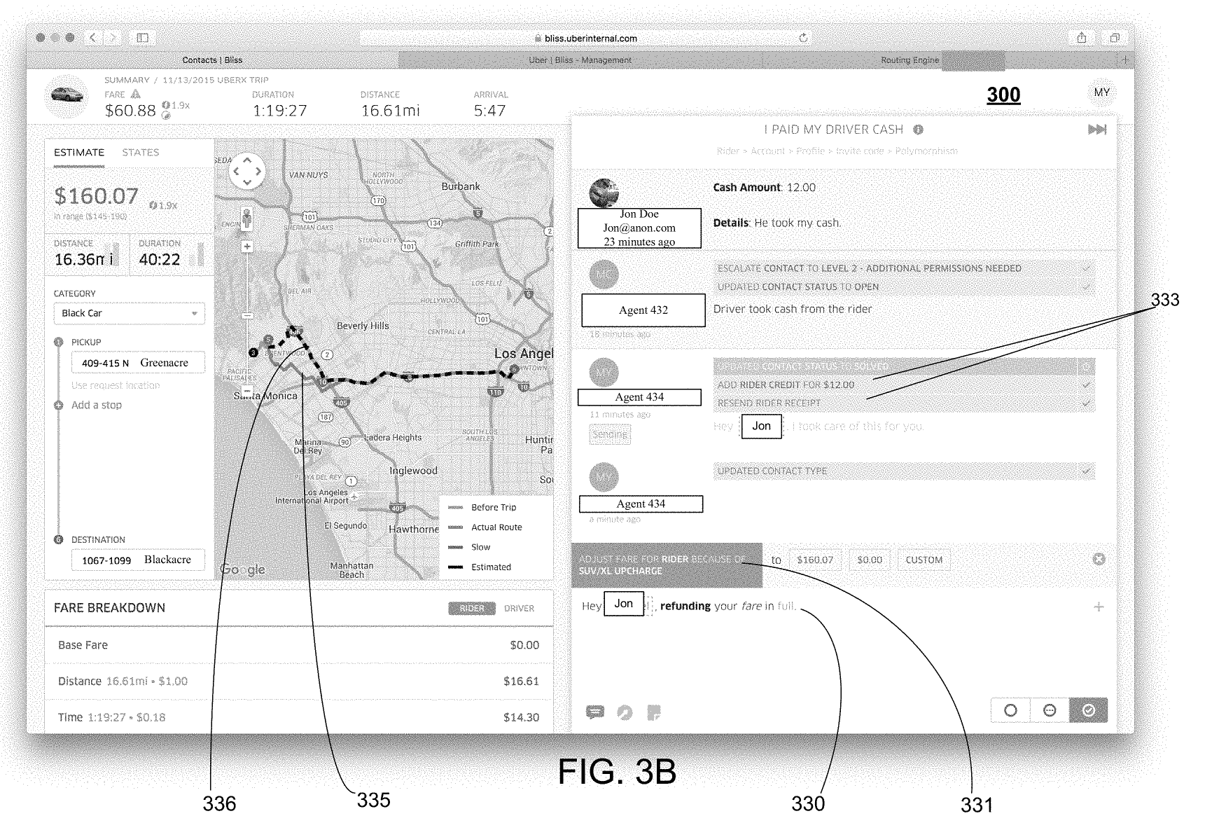

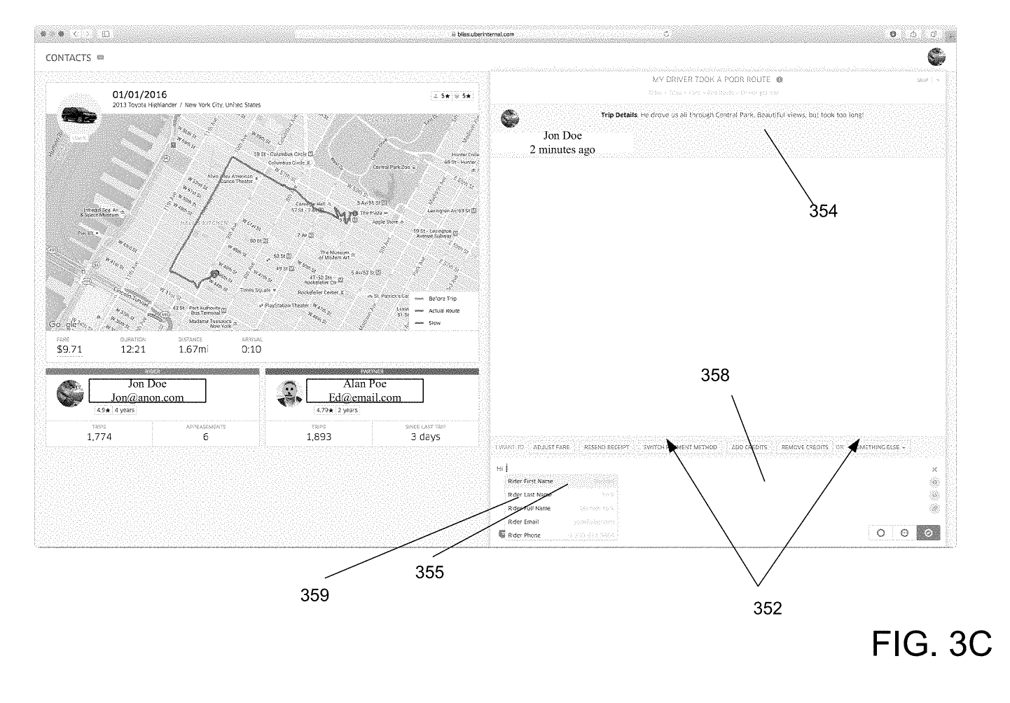

FIG. 3A through FIG. 3C each illustrate an agent interface that implements functionality provided through the issue resolution platform 220. Accordingly, references made to elements of an example of FIG. 2 are intended to illustrate suitable components and context for implementing an aspect being described.

FIG. 3A illustrates an issue resolution interface 300 that can be generated by the agent interface component 216 of the issue resolution platform. The issue resolution interface 300 can be generated in response to a resolution request 304, generated from a customer operating the client device 102. In the context of transport services, the customer may initiate a complaint or raise an issue that the driver or service provider requested cash payment from the customer (when the service provider should not have), chose the wrong or less-than-optimal route trip, or committed some other grievance. The service application 112 of the client device 102 can retrieve or otherwise identify the trip in question, and components such as the record manager 214 can access data sources to aggregate and present content that corresponds to the event record 215 for the issue resolution. In the example provided, the issue resolution interface 300 displays the trip information 301, which can include information about the trip that is the subject of the user's complaint. The trip information 301 can depict, for example, a map, a route which was taken for the user, known contextual information such as time of day, weather, and traffic conditions along alternative routes.

In the example provided, the trip information 301 may be depicted with account information 302 for the user. Additionally, the issue resolution interface 300 can depict information about the service provider (e.g., using a service provider profile store), along with trip services service provider profile 303. The issue resolution interface 300 can also identify the details of issue resolution request 304 as entered by the user at client device 102. The issue resolution interface 300 can also provide information about the issue category 306 which can be determined for the issue resolution request 304. The issue resolution interface 300 is shown to also include an action bar 305, which can enable the human agent to perform one or more different resolution actions (e.g., perform a requested action, send message, escalate etc.).

FIG. 3B illustrates a variation or alternative implementation of the issue resolution interface 300. In the example of FIG. 3B, the complaint or subject of the issue resolution request is that a driver took an incorrect route. In such an implementation, a depiction of the actual route 335 traveled for the trip and a depiction of an alternate route 336 may be provided within interface 300, to aid in clarifying and resolving the complaint, for instance, to view detailed information about trip 301 and determine whether the best or optimal route was taken by service provider 103. The alternate route 336 may correspond to a more efficient route (e.g., resulting in a faster trip and/or a cheaper trip for the rider customer based on price parameters at the time of the trip request or trip, etc.) that the driver may have taken at the time of the trip.

With further reference to an example of FIG. 3B, a history of interaction between the agent and the user is shown, with additional interaction between agents when there is an escalation. In the example shown, the agent is able to automate implementation of actions through selection of action entries 333, which can specify a desired task or outcome. For example, the agent can select an action of “refund full” and multiple actions are then queued: (i) user is to be refunded in full, with the amount being automatically determined based on the user account, or other system side information; (ii) the user is to be provided a new receipt; (iii) a portion of a message from the agent to the customer is composed for the user (“Hey <firstname> refunding your fare in <value>.”). An internal message can also be queued for archive or analysis. The actions which are queued can be performed on the trigger of the user sending the outgoing message.

FIG. 3C illustrates a variation or alternative implementation of the issue resolution interface 300. In an example of FIG. 3C, the issue resolution interface 300 includes functionality for facilitating the human agent in inserting user-specific (or event-specific) information into an issue resolution message that is composed for the specific issue that the customer is complaining about. The issue resolution interface 300 can generates a message 354 from the user, with the message including content submitted by the user when making the resolution request. The response panel 358 provides an area where the user human agent can view, select or compose a response. The response of the human agent can include, for example, (i) content created by the agent (e.g., agent types an answer), (ii) content selected by the agent (e.g., agent selects a pre-determined response or template), and/or (iii) the agent has available a list of variables which are issue specific (e.g., list aspects of the user account). For example, the user can compose or select non-specific text (e.g., “Hello”), then select variable inserts. For example, the agent may compose “Hello” and then select the variable “<First Name>” an then compose “long time user of” and then select the variable <userterm> and then compose “!”, to generate the sentence “Hello Michael, long time user of 3 years!”.

Alternative interfaces 355 can be provided to enable an agent to specify variables or other dynamic values for a response. In the example provided, the interface 355 is a panel, with selectable items 359 corresponding to variables which the agent can select. In some variations, the variables 359 provided with the panel are specific to context, such as the issue category or the action the agent has elected to perform.

In combination with the composition, the agent can select automatic resolution action features 352, which when selected, cause a corresponding action to be performed for the user, user account, and/or service provider. Each feature 352 can be associated with at least one action, and in many cases, the features are outcomes which result in multiple actions being performed automatically to achieve or progress to the outcome. For example, the agent can select “Adjust fare” which results in the following actions: (i) agent is provided an interface to specify the adjustment, optionally in context of the specific transaction (e.g., limit discount to portion of actual fare); (ii) non-user-specific text that is pre-selected for the action (and/or optionally selected for the issue) is automatically rendered for an outgoing message (“We are sorry for the experience, we would like to credit you a partial refund”); and (iii) once the agent specifies a value of the adjustment, the action or outcome is queued for a triggering event.

In the example provided, the triggering event for the action or outcome to be performed can correspond to the agent sending the message. Additionally, the non-user-specific text can be personalized further by the agent selecting to insert variables (e.g., “We are sorry for the experience <First Name>, we would like to credit you a partial refund”). Still further, the agent interface can display values for variables which are automatically selected, based on the action (“Adjust Fare”) selected by the agent (e.g., “We are sorry for the experience <FirstName>, we would like to credit you a partial refund of <$6.35>, which is about one third of the fare you were charged.”).

When the triggering event occurs (e.g., agent sends message), the queued action or outcome is performed. In the example provided, this can mean that the user's account is credited, and possibly the service provider's account is debited. At the same time, the message can be sent to the user, and/or to other recipients (including interior and exterior sources).

Alternative sequences can be used to prompt the agent for input, in order to automate the message with agent input. For example, the agent can select the feature 352, specify the user specific information, and then have the interface 300 generate the outgoing message automatically, while automating one or more actions of the queued outcome.

### Methodology

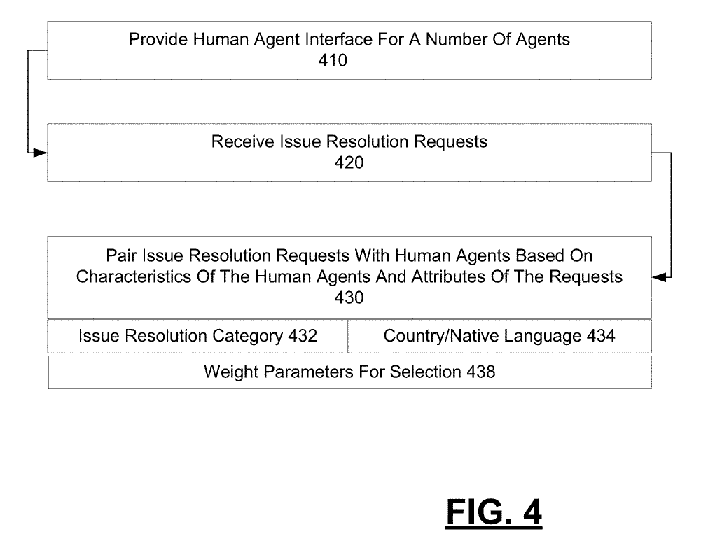

FIG. 4 illustrates an example method for implementing an issue resolution platform, according to one or more examples. A method such as described with an example of FIG. 4 can be implemented using components such as described with examples of FIG. 1 and FIG. 2. Accordingly, reference may be made to elements of FIG. 1 and FIG. 2 for purpose of illustrating suitable components or elements for performing a step or sub-step being described.

An issue resolution platform may be implemented a network computer system to provide a human agent interface for a number of human agents that work to resolve issues arising with operations of an enterprise (410). Specific examples provide human agents to resolve issues with respect to the demand workforce service, such as a transport arrangement service. Examples recognize that such enterprises raise challenges with quality control, given that service providers are also users, without and that the deployment of such service providers is with less centralization and control as compared to conventional practices. According to some examples, human agents can correspond to individuals that reside in various parts of the world. The human agent interface can be provided through, for example, a web browser, where the human agent can access a website or portal in order to download the human agent interface onto a computer used by that agent. In variations, the human agent interface can be provided through, for example, a dedicated client application that executes on a terminal operated by the human agent.

In the course of the day (or portion thereof), the issue resolution platform 220 can receive a plethora of issue resolution requests, relating to services received or provided by respective customers and/or service providers (420). While some examples previously described herein or for a customer complaining about a service provider, variations can also extend to service providers to complain about customers. In many on-demand workforce services, both customer and service providers are users, and examples provide for a reality in which an operator of the service has ability to affect an account, uses privilege, or other facet of the particular user with respect to using or being part of the on-demand service.

The issue resolution platform 220 can pair incoming issue resolution request with human agents based on a variety of factors, including characteristics of the human agents and attributes of the incoming requests. In particular, incoming issue resolution requests can be associated with a resolution category, which can be descriptive of an underlying subject that is the focus of the issue (432). Additionally, human agents that are available for handling incoming issue resolution request can have characteristics that are in favor or against selection of that particular human agent and a particular issue resolution requests. Specific characteristics which can affect selection of the human agent for or against a particular issue resolution request include a country of residence of the human agent (e.g., where the human agent is resident when the incoming issue resolution quest is received) (434).

Examples further recognize that intelligent pairing between incoming issue resolution requests and human agents is a mechanism for optimizing (e.g., reducing response time until resolution is complete) the handling of issue resolution requests. Among other considerations, intelligent pairing of incoming issue resolution requests and human agents can include excluding the pairing of human agents who may have cultural or legal ramifications in dealing with a particular issue resolution request. For example, pairing component 211 of the issue resolution platform 220 can exclude (or include) pairings based on attributes such as country of residence of the human agent, native language of the human agent as compared to the complainant, or other profile information about the human agent. The human agent and the site of the complainant can thus be in different geographic regions. For example, a user in California may have an unsatisfactory experience with a service provider, leading to the user generating the issue resolution request. The human agent handling the issue resolution request may be in another state or country. In some examples, the country in which the human agent resides in can factor into the selection (or exclusion) of the human agent for or against a particular incoming issue resolution request.

Numerous examples further recognize that rapid and intelligent selection of human agents for incoming issue resolution request can reduce the number of human agents needed, while ensuring that the queue of the issue resolution request does not build over time. In particular, examples recognize that the assignment of human agents to issue resolution requests (the wait time for assigning an issue resolution request) should be more expedient than an average time between the arrival of two or more issue resolution request, when averaged over a given period of time (e.g., half or full day etc.). Given a large enough population of users, the number of human agents handling issue resolution requests can result in incoming issue resolution requests being assigned to appropriate human agents within a fraction of a second from when the issue is received.

While optimization reduces wait time for purpose of assigning human agents to issue resolution requests, examples recognize that expediency is not necessarily a primary objective for at least some issue resolution requests. In some examples, attributes or characteristics used in pairing human agents with incoming issue resolution requests can be weighted. The weighting of such parameters can prioritize a target human agent (or group of human agents from a larger pool) for assignment to a particular issue resolution request, given, for example, a background of the human agent with respect to the category of the issue resolution request, a history of the particular human agent with the specific user making the request, the background the particular human agent with respect to a background of the user making the request, and/or a country or native language of the human agent. The weighting can prioritize selection of the human agent over expediency (438), meaning that the wait time for the issue resolution requested to be assigned to the appropriate human agent can be delayed when appropriate.

It is contemplated for embodiments described herein to extend to individual elements and concepts described herein, independently of other concepts, ideas or system, as well as for embodiments to include combinations of elements recited anywhere in this application. Although embodiments are described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mention of the particular feature. Thus, the absence of describing combinations should not preclude the inventor from claiming rights to such combinations.

What is being claimed is:

1. A method for servicing issue resolution requests, the method being implemented by one or more processors and comprising:
providing a human agent interface for each human agent in a number of human agents;
receiving issue resolution requests from a population of users, the population of users being distributed over a geographic region;
assigning individual issue resolution requests to a corresponding human agent from the number of human agents, based at least in part on respective attributes of each issue resolution request and one or more characteristics of the corresponding human agent that is assigned to the issue resolution request; and
wherein over a period of at least a portion of the day, assigning individual issue resolution requests is performed on average at a faster rate than an average rate at which issue resolution requests are received.

2. The method of claim 1, wherein assigning individual issue resolution requests to the corresponding human agent is performed, on average over the period, in less than a second.

3. The method of claim 1, wherein the number of human agents collectively reside in multiple countries.

4. The method of claim 3, wherein the one or more characteristics of the human agent are based on the country where the human agent resides.

5. The method of claim 3, wherein the one or more characteristics of the human agent are based on a native language of the human agent.

6. The method of claim 1, further comprising automatically performing a resolution action in response to an action by the selected human agent.

7. A method for servicing issue resolution requests, the method being implemented by one or more processors and comprising:
receiving an issue resolution request from a client device operated by a user, the issue resolution request identifying an issue arising in connection with the user receiving a service from a service provider;
selecting, from a pool of human agents, a human agent based at least in part on an attribute of the issue resolution request and a characteristic of the human agent that is specific to at least a sub-category of human agents in the pool; and
automatically performing a resolution action in response to an action by the selected human agent.

8. The method of claim 7, wherein selecting the human agent based at least in part on the human agent characteristic of a geographic region of residence for the human agent or a native language of the human agent.

9. The method of claim 7, wherein automatically performing the resolution action includes (i) identifying information from a message that is completed by the selected human agent, and (ii) performing an issue resolution action using information contained in the message in response to the selected human agent sending the message.

10. The method of claim 9, wherein performing the issue resolution action includes automatically accessing and updating an account of the user to deposit a fund or credit.

11. The method of claim 7, further comprising rendering, as part of a human agent interface provided on a display of a computer operated by the human agent, information relevant to the issue resolution request, including a category of the issue resolution request, profile information about the user, and profile information about the service provider, wherein the relevant information is retrieved and aggregated automatically in response to the issue resolution request being received.

12. The method of claim 7, wherein the attribute corresponds to a category designation of the issue resolution request.

13. The method of claim 7, wherein selecting the human agent includes assigning a weight to one or more attributes that are associated with or determined from the issue resolution request.

14. The method of claim 13, wherein a weighted value of the one or more attributes affects a duration of time before the issue resolution request is assigned.

15. The method of claim 1 further comprising:
extracting text from a message completed by the human agent as the action; and
retaining the extracted text as a template for generating subsequent resolution actions for issue resolution requests that are deemed similar.

16. A system for servicing an issue resolution request in a queue of requests, the system comprising:
a memory to store instructions;
one or more processors that execute the instructions to:
receive an issue resolution request from a client device operated by a user, the issue resolution request identifying an issue arising in connection with the user receiving a service from a service provider;
select, from a pool of human agents, a human agent based at least in part on an attribute of the issue resolution request and a characteristic of the human agent that is specific to at least a sub-category of human agents in the pool; and
automatically perform a resolution action in response to an action by the selected human agent.

17. The computer system of claim 16, further comprising a collection of service applications, deployed and made operation on corresponding client devices.

18. The computer system of claim 16, wherein the one or more processors select the human agent based at least in part on the human agent characteristic of a geographic region of residence for the human agent or a native language of the human agent.

19. The computer system of claim 16, wherein the one or more processors automatically perform the resolution action by (i) identifying information from a message that is completed by the selected human agent, and (ii) performing an issue resolution action using information contained in the message in response to the selected human agent sending the message.

20. The computer system of claim 19, wherein the characteristic of the human agent is based on the country where the human agent resides.
